(19) United States
(12) Patent Application Publication
(10) Pub. No.: US 2025/0094802 A1
(43) Pub. Date: Mar. 20, 2025

(54) MODEL TRAINING METHOD, MODEL REASONING METHOD, ELECTRONIC DEVICE, AND STORAGE MEDIUM

(71) Applicant: Beijing Baidu Netcom Science Technology Co., Ltd., Beijing (CN)

(72) Inventors: Junyuan SHANG, Beijing (CN); Guoxia WANG, Beijing (CN); Yinqi YANG, Beijing (CN); Shuohuan WANG, Beijing (CN); Yu SUN, Beijing (CN)

(21) Appl. No.: 18/965,684

(22) Filed: Dec. 2, 2024

(30) Foreign Application Priority Data
Sep. 23, 2024 (CN) 202411328132.7

(51) Int. Cl. G06N 3/08; G06F 40/284

(52) U.S. Cl. CPC G06N 3/08; G06F 40/284

(57) ABSTRACT

Provided is a model training method, a model reasoning method, an electronic device, and a storage medium, relating to the field of data processing, and especially to the technical fields of artificial intelligence, big data, deep learning and large models. The model training method includes: folding an initial token sequence for training a model based on a folding feature value for folding a token sequence to obtain at least a first token sequence subjected to the folding, wherein the initial token sequence represents a token sequence composed of T₁ tokens, and the first token sequence has a sequence length less than that of the initial token sequence; and inputting at least the first token sequence into a preset model to train the preset model so as to obtain a target model.

### CROSS-REFERENCE TO RELATED APPLICATIONS

The present application claims priority to Chinese Patent Application No. CN202411328132.7, filed with the China National Intellectual Property Administration on Sep. 23, 2024, the disclosure of which is hereby incorporated herein by reference in its entirety.

### TECHNICAL FIELD

The present disclosure relates to the technical field of data processing, and especially to the technical fields of artificial intelligence, big data, deep learning and large models.

### BACKGROUND

At present, the natural language field is developing towards the era of hyperscale models. Training hyper-parametric models on massive textual data by means of the super computing power can enable the output language models to have general semantic understanding and generating capabilities of multi-task and few-shot learning. Large models have computational consumption and video memory footprints that increase in square level with the length of the inputs while demonstrating strong generalization capabilities, which brings the significant cost overhead for training and deploying models, and additionally limits their capabilities to solve long-text tasks.

### SUMMARY

The present disclosure provides a model training method and apparatus, a model reasoning method and apparatus, and an electronic device.

According to an aspect of the present disclosure, provided is a model training method, including:
folding an initial token sequence for training a model based on a folding feature value for folding a token sequence to obtain at least a first token sequence subjected to the folding, where the initial token sequence represents a token sequence composed of T₁ tokens, and the first token sequence has a sequence length less than that of the initial token sequence; and
inputting at least the first token sequence into a preset model to train the preset model so as to obtain a target model.

According to another aspect of the present disclosure, provided is a model reasoning method, including:
obtaining an initial to-be-reasoned token sequence;
folding the initial to-be-reasoned token sequence based on a folding feature value for folding a token sequence to obtain at least a first target to-be-reasoned token sequence, where the initial to-be-reasoned token sequence represents a token sequence composed of T₂ tokens, and the first target to-be-reasoned token sequence has a sequence length less than that of the initial to-be-reasoned token sequence; and
inputting at least the first target to-be-reasoned token sequence into a target model to obtain a target reasoning result, where the target reasoning result is a next token sequence of the target to-be-reasoned token sequence obtained from prediction.

According to another aspect of the present disclosure, provided is a model training apparatus, including:
a first data processing unit, configured to fold an initial token sequence for training a model based on a folding feature value for folding a token sequence to obtain at least a first token sequence subjected to the folding, where the initial token sequence represents a token sequence composed of T₁ tokens, and the first token sequence has a sequence length less than that of the initial token sequence; and
a model training unit, configured to input at least the first token sequence into a preset model to train the preset model so as to obtain a target model.

According to another aspect of the present disclosure, provided is a model reasoning apparatus, including:
a second data processing unit, configured to obtain an initial to-be-reasoned token sequence, and fold the initial to-be-reasoned token sequence based on a folding feature value for folding a token sequence to obtain at least a first target to-be-reasoned token sequence, where the initial to-be-reasoned token sequence represents a token sequence composed of T₂ tokens, and the first target to-be-reasoned token sequence has a sequence length less than that of the initial to-be-reasoned token sequence; and
a model reasoning unit, configured to input at least the first target to-be-reasoned token sequence into a target model to obtain a target reasoning result, where the target reasoning result is a next token sequence of the target to-be-reasoned token sequence obtained from the prediction.

According to another aspect of the present disclosure, provided is an electronic device, including:
at least one processor; and
a memory, connected in communication with at least one processor,
where the memory stores an instruction executable by at least one processor, and the instruction, when executed by the at least one processor, enables the at least one processor to perform the method of any one of embodiments of the present disclosure.

According to another aspect of the present disclosure, provided is a non-transitory computer-readable storage medium storing a computer instruction thereon, where the computer instruction is used to cause a computer to perform the method of any one of embodiments of the present disclosure.

According to another aspect of the present disclosure, provided is a computer program product, including a computer program that when executed by a processor, implements the method of any one of embodiments of the present disclosure.

In this way, according to the solution provided in the present disclosure, the initial token sequence can be folded based on the folding feature value, and a token sequence subjected to the folding (i.e., the first token sequence) with a length less than that of the initial token sequence is obtained. Further, the preset model is trained by using the token sequence subjected to the folding. As such, the model training efficiency is improved by compressing the input of the model, and the foundation for improving the model reasoning efficiency in the future is laid.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

Accompanying drawings are intended for a better understanding of this solution and do not constitute a limitation on the present disclosure. In the figures:

FIG. 1 is a first schematic flowchart of a model training method according to an embodiment of the present disclosure;

FIG. 2 is a first schematic diagram of an initial token sequence before and after being subjected to the folding in an example according to an embodiment of the present disclosure;

FIG. 3 is a second schematic flowchart of a model training method according to an embodiment of the present disclosure;

FIG. 4 is a second schematic diagram of an initial token sequence before and after being subjected to the folding in an example according to an embodiment of the present disclosure;

FIG. 5(a) is a schematic illustration of information of an input of a preset model according to an embodiment of the present disclosure;

FIG. 5(b) is a schematic structural diagram of N network layers in a preset model according to an embodiment of the present disclosure;

FIG. 6(a) is a schematic illustration of information of an input of a non-first layer in a preset model according to an embodiment of the present disclosure;

FIG. 6(b) is a schematic illustration of information of an input of each layer in a preset model according to an embodiment of the present disclosure;

FIG. 7 is a third schematic flowchart of a model training method according to an embodiment of the present disclosure;

FIG. 8 is a schematic illustration of output information of some network layers in a preset model according to an embodiment of the present disclosure;

FIG. 9 is a schematic flowchart of a model reasoning method according to an embodiment of the present disclosure;

FIG. 10 is a schematic diagram of a prediction scenario of a model reasoning method in a specific example according to an embodiment of the present disclosure;

FIG. 11 is a schematic structural diagram of a model training apparatus according to an embodiment of the present disclosure;

FIG. 12 is a schematic structural diagram of a model reasoning apparatus according to an embodiment of the present disclosure; and

FIG. 13 is a block diagram of an electronic device for implementing a model training method or a model reasoning method according to an embodiment of the present disclosure.

### DETAILED DESCRIPTION

Exemplary embodiments of the present disclosure will be described hereinafter in conjunction with accompanying drawings, which include various details of the embodiments of the present disclosure to aid in understanding and which should be considered merely exemplary. Accordingly, those ordinarily skilled in the art should recognize that various changes and modifications can be made to the embodiments described herein without departing from the scope of the present disclosure. Similarly, descriptions of well-known features and structures will be omitted from the following description for the sake of clarity and brevity.

The term “and/or” as used herein is merely a description of an association relation of associated objects, which indicates that may be three types of relations, for example, A and/or B may indicate that only A exists, or both A and B exist, or only B exists. The term “at least one” as used herein indicates any one of a plurality or any combination of at least two of the plurality, for example, including at least one of A, B and C, and may indicate the inclusion of any one or more elements selected from a set consisting of A, B and C. The terms “first” and “second” herein are used to refer to and distinguish between a plurality of similar technical terms, and are not meant to define an order, or to define only two. For example, a first feature and a second feature refer to two types/two features. The first feature may mean one or more, and the second feature may mean one or more.

In addition, in order to better illustrate the present disclosure, numerous specific details will be presented in the following detailed description. It should be understood by those skilled in the art that the present disclosure can be equally implemented without certain specific details. In some instances, methods, means, elements and circuits well known to those skilled in the art are not described in detail, in order to highlight the subject of the present disclosure.

The solution provided in the present disclosure provides a model training method to improve training efficiency of a large model.

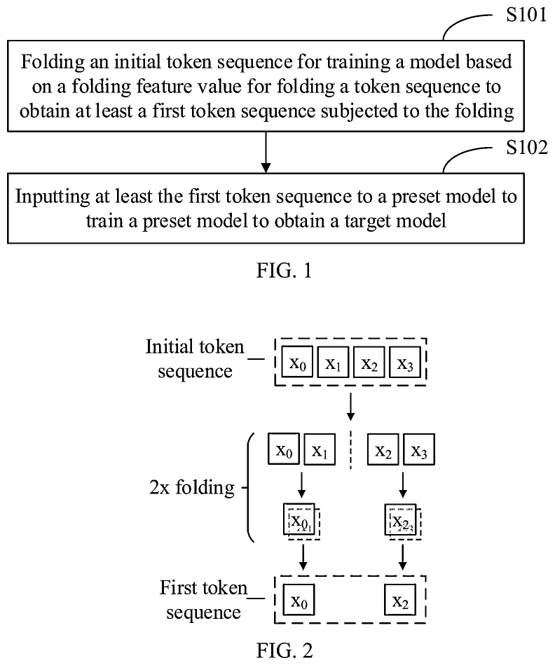

Particularly, FIG. 1 is a first schematic flowchart of a model training method according to an embodiment of the present disclosure. The method can be optionally applied to an electronic device, for instance, a personal computer, a server and a server cluster.

Further, the method includes at least a portion of the following content. As shown in FIG. 1, the method includes the following steps.

Step S101: An initial token sequence for training a model is folded based on a folding feature value for folding a token sequence to obtain at least a first token sequence subjected to the folding.

Here, the initial token sequence represents a token sequence composed of T₁ tokens, and the first token sequence obtained after the folding is performed includes some tokens of T₁ tokens. Further, the first token sequence has a sequence length less than that of the initial token sequence.

For instance, in an example, the initial token sequence is folded in depth to obtain the first token sequence subjected to the folding. As such, the length of the input token is effectively compressed. In other words, the number of the tokens input to a preset model for the first time is reduced, which lays the foundation for improving the model training efficiency and the model reasoning efficiency in the future. For example, as shown in FIG. 2, the initial token sequence containing 4 tokens is denoted as {x₀, x₁, x₂, x₃}. Assuming the folding feature value is 2, the initial token sequence {x₀, x₁, x₂, x₃} is folded twice by using the folding feature value, such that the first token sequence subjected to the folding can be obtained and denoted as {x₀, x₂}.
Step 102: At least the first token sequence is input into the preset model to train the preset model so as to obtain a target model.

In this way, according to the solution provided in the present disclosure, the initial token sequence can be folded according to the folding feature value to a token sequence subjected to the folding (i.e., the first token sequence) with a length less than that of the initial token sequence. Further, the preset model is trained by using the token sequence subjected to the folding. As such, the model training efficiency is improved by compressing the input of the model, which lays the foundation for improving the model reasoning efficiency in the future.

Further, in the solution provided in the present disclosure, since the input length of the model is compressed, the computational complexity and video memory resource footprints can be effectively reduced, and further the cost required for training and deploying the model can be lowered. In addition, according to the solution provided in the present disclosure, the capability of the model to solve long-text tasks (for instance, long-text summarization and long-text questions and answers) is effectively improved.

In a specific example, the preset model can be particularly a large model. Furthermore, the preset model can be particularly a large language model. Alternatively, other models are also possible, and are not limited here.

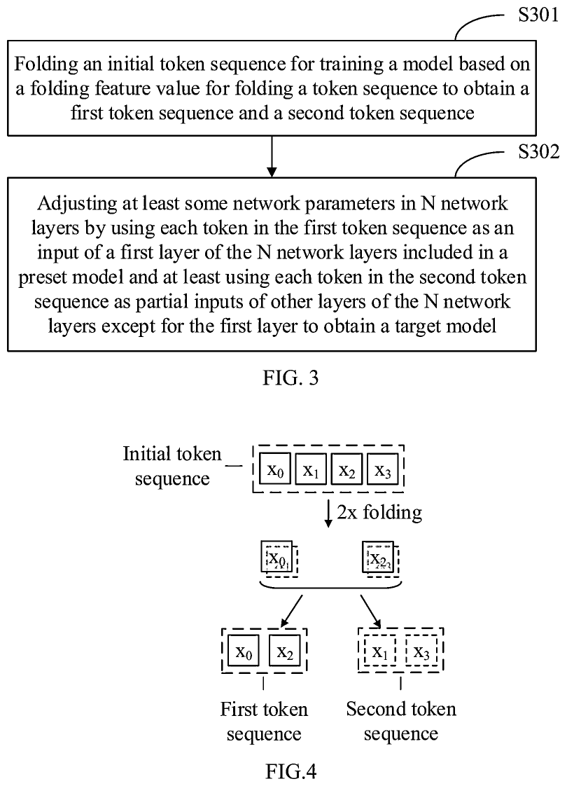

FIG. 3 is a second schematic flowchart of a model training method according to an embodiment of the present disclosure. The method can be optionally applied to an electronic device, for instance, a personal computer, a server and a server cluster. It can be understood that relevant contents of the methods shown in FIG. 1 and FIG. 2 above can be applied to the example, and will be omitted in this example.

Further, the method includes at least a portion of the following content. As shown in FIG. 3, the method includes the following steps.
Step S301: An initial token sequence for training a model is folded based on a folding feature value for folding a token sequence to obtain a first token sequence and a second token sequence.

Here, the initial token sequence represents the token sequence composed of T₁ tokens, and the first token sequence has a sequence length less than that of the initial token sequence.

Further, the first token sequence includes t₁₁ tokens displayed after being subjected to the folding, where the t₁₁ tokens are a part of the T₁ tokens. Further, the second token sequence includes t₁₂ tokens hidden by the tokens displayed after being subjected to the folding, where the t₁₂ tokens are a part of the T₁ tokens. Here, t₁₁+t₁₂=T₁.

For example, continuing with FIG. 2 as an example, two tokens (i.e., the first token sequence {x₀, x₂}) displayed after being subjected to the folding as shown in FIG. 4 and two tokens (i.e., the second token sequence {x₁, x₃}) hidden by the tokens displayed after being subjected to the folding can be obtained after the initial token sequence {x₀, x₁, x₂, x₃} is folded twice.
Step 302: At least some network parameters in the N network layers are adjusted by using each token in the first token sequence as an input of a first layer of the N network layers included in the preset model and at least using each token in the second token sequence as some inputs of other layers of the N network layers except for the first layer to obtain the target model. For instance, the at least some network parameters in the N network layers are fine-tuned to obtain the target model.

For instance, in an example, each token in the first token sequence is inputted into a corresponding position of the first layer in the preset model in an order of each token in the first token sequence. Here, “position” can particularly refer to an input position of the token.

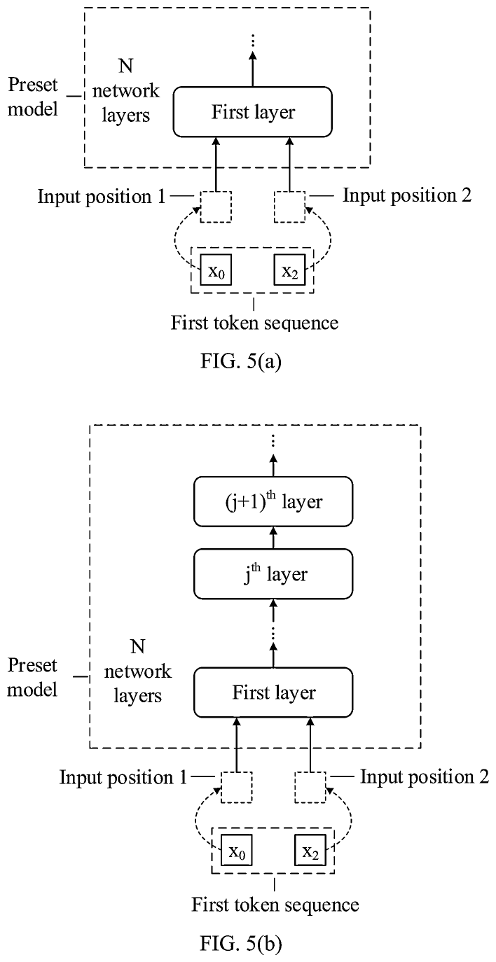

For example, continuing with the initial token sequence shown in FIG. 4 and obtaining the first token sequence {x₀, x₂} and the second token sequence {x₁, x₃} as examples, as shown in FIG. 5(a), a token x₀ in the first token sequence {x₀, x₂} can be input to a position 1 of the first layer included in the preset model and a token x₂ in the first token sequence {x₀, x₂} can be input to a position 2 of the first layer according to an order of each token in the first token sequence {x₀, x₂}.

In this way, according to the solution provided in the present disclosure, each token in the first token sequence subjected to the folding is used as the input of the first layer in the preset model and each token in the second token sequence is used as the inputs of other layers in the preset model except for the first layer. As such, the integrity of information of the input after the input of the model is compressed can be effectively ensured, and further the model training speed is increased while no influence on the model training effect is ensured, which lays the foundation for improving the model reasoning efficiency and reducing the cost required for training and deploying the model in the future.

Further, in an example, the N network layers are connected in series, and an output of a j^{th} layer of the N network layers serves as an input of a (j+1)^{th} layer of the N network layers. For instance, as shown in FIG. 5(b), when a value of j is an integer greater than or equal to 0 and less than N, the output of the j^{th} layer of the N network layers included in the preset model serves as the input of the (j+1)^{th} layer of the N network layers. When the value of j is 0, the input of a 0^{th} layer (also referred to be as the first layer) is the first token sequence. When the value of j is (N−1), an output of an (N−1)^{th} layer is an output of the last layer in the preset model. As such, layer-wise feature extraction can be performed on the information of the input, such that richer and deeper information is captured, which lays the foundation for improving the model predicting accuracy and robustness.

In a specific example of the solution provided in the present disclosure, the input of each layer of the N network layers can be obtained in the following way, and particularly includes the following step:
determining an input of the j^{th} layer based on the folding feature value and a position where the j^{th} layer of the N network layers is located in the N network layers, where j has a value depending on the N. For instance, the value of j is a natural number greater than or equal to 0 and less than or equal to (N−1).

Further, in an example, determining the input of the j^{th} layer based on the folding feature value and the position where the j^{th} layer of the N network layers is located in the N network layers may particularly include:
determining the input of the j^{th} layer based on a numerical relationship between a number where the j^{th} layer is located in the N network layers and the folding feature value.

That is, in this example, the input of the first layer (for instance, when the value of j is 0) of the N network layers included in the preset model is the first token sequence, and inputs of other layers of the N network layers except for the first layer (i.e., when the value of j is an integer greater than 0 and less than N) are determined according to the numerical relationship between the number where the j^{th} layer is located in the N network layers and the folding feature value. As such, provided is a refined solution for determining other token sequences in the initial token sequences except for the first token sequence are input to the preset model, which is simple and efficient.

In this way, the solution provided in the present disclosure provides a refined solution for determining how to input other token sequences (i.e., tokens covered by the folding) except for the first token sequence into the preset model based on a folding degree of the information of the input, which is simple and efficient. As such, the information loss caused by folding the information of the input of the model is effectively avoided, the computational load of each network layer is balanced, and the burden on the server when the information is processed by the model is reduced, which lays the foundation for increasing the model training speed and reducing the cost required for training and deploying the model.

Further, in a specific example, the input of the j^{th} layer can be particularly obtained in the following way. Particularly, determining the input of the j^{th} layer based on the numerical relationship between the number where the j^{th} layer is located in the N network layers and the folding feature values can particularly include at least one of the following two manners.

In a first manner: the input of a non-first layer (for instance, when j has a value ranging from 1 to (N−1)) is determined. Particularly, in a case where the number (for instance, which can be understood as a value of j) where the j^{th} layer is located in the N network layers is less than the folding feature value (for instance, in an example, if (the depth-of-layer minus 1) is less than the folding feature value s), the input of the j^{th} layer is obtained based on an implicit output result of a (j−1)^{th} layer and at least one token in the second token sequence.

It should be noted that in this example, the number where the j^{th} layer is located in the N network layers can particularly refer to the value of j. Further, the depth-of-layer can particularly refer to a position where the layer is located in all the layers. For instance, for the first layer of the four layers, the depth of the first layer can be 1, and the depth of the next layer is 2.

Here, the implicit output result can be particularly understood as the implicit result obtained after the token is processed by the network layer.

It should be noted that in an example, j has a value ranging from 0 to (N−1). Further, the solution provided in the present disclosure provides an exemplary explanation made by using j having a value ranging from 0 to (N−1) as an example. It can be understood that j has a value ranging from 1 to N. In this case, corner markers can be adjusted accordingly based on an actual value, and are not limited herein.

It can be understood that the input of the first layer (for instance, the value of j is 0) is each token in the first token sequence. The input of the non-first layer can be obtained based on the manner 1. For instance, if the value of j is 1 and the folding feature value is 2, in this case, j is less than s or (the depth-of-layer minus 1) (for instance, 2 minus 1) is less than 2, then the input of the first layer can be particularly an implicit output result of the 0^{th} layer and at least one token (i.e., one token covered by the folding) in the second token sequence. In other words, in a scenario, for some layers meeting conditions, in addition to using the implicit output result output from the previous layer (for instance, the (j−1)^{th} layer) as the input of the next layer (for instance, the j^{th} layer), it is necessary to introduce the token hidden by the token displayed after being subjected to the folding as another input of the next layer (for instance, the j^{th} layer). As such, the foundation for effectively avoiding the loss of information of the original input is laid.

Further, in an example, obtaining the input of the j^{th} layer based on the implicit output result of the (j−1)^{th} layer and the at least one token in the second token sequence as described in the first manner may particularly include:
obtaining an input of an i^{th} position of the j^{th} layer based on an implicit output result h 1 of an i^{th} position of a (j−1)^{th} layer and a token x_{j+i×s}.

Here, j represents a number where a layer is located; i represents an input position of a token, i has a value depending on a value of the T₁ and the folding feature value. For instance, in an example, i has a value ranging from 0 to [(T₁/s)−1]. s represents the folding feature value.

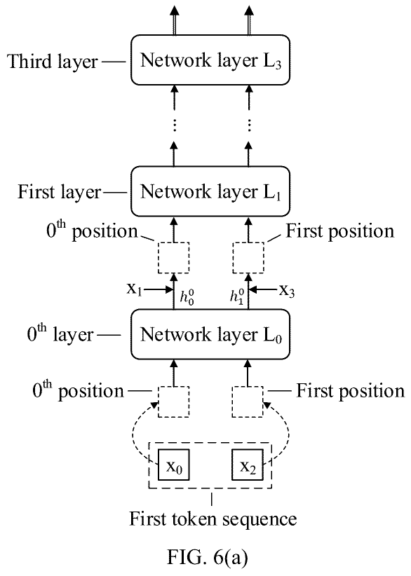

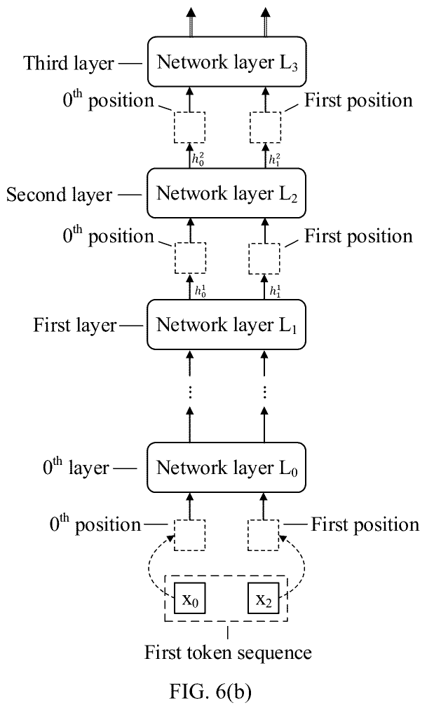

For example, taking a preset model consisting of four network layers (which can be denoted as {L₀, L₁, L₂, L₃}) for example and continuing with the initial token sequence {x₀, x₁, x₂, x₃} being folded twice to obtain the first token sequence {x₀, x₂} and the second token sequence {x₁, x₃} as an example, j has a value ranging from 0 to 3, and i has a value of 0 or 1. Further, as shown in FIG. 6(a), for instance, the first layer can be denoted as a 0th layer L₀ (i.e., a j has a value of 0). In this case, an input of a 0^{th} position (i has a value of 0) of the 0^{th} layer L₀ is x₀, and an input of a first position (i has a value of 1) of the 0th layer L₀ is x₂. Further, for the first layer L₁, a value of j is 1, and in this case, j<s, the input of the 0^{th} position of the first layer L₀ can be obtained according to an implicit output result h₀⁰ of the 0^{th} position of the 0^{th} layer L₀ in the preset model and a token x₁ in the second token sequence. Correspondingly, the input of the first position of the first layer L₁ can be obtained according to an implicit output result h₁⁰ of the first position of the 0^{th} layer L₀ in the preset model and a token x₃ in the second token sequence.

In this way, according to the solution provided in the present disclosure, at least one token in the second token sequence is additionally introduced into the input of the network layer meeting a depth-of-layer requirement. As such, the loss of the information of the original input is effectively avoided. In other words, according to the solution provided in the present disclosure, a specific position of an input required by the compressed token is obtained by utilizing the depth dimension of the network layer while the input of the preset model is compressed, such that the loss of the information of the original input is avoided, and the model training effect is ensured while the foundation for improving the model reasoning efficiency and reducing the cost required for training and deploying the model in the future is laid.

Further, in a specific example, obtaining the input of the i^{th} position of the j^{th} layer based on the implicit output result hᵢ^{j-1} of the i^{th} position of the (j−1)^{th} layer and the token x_{j+i×s} may particularly include:
fusing the implicit output result hᵢ^{j-1} of the i^{th} position of the (j−1)^{th} layer and the token x_{j+i×s} by using a deep folding function so as to use a fused result as the input of the i^{th} position of the j^{th} layer.

For example, in an example, the input of the i^{th} position of the j^{th} layer can be denoted as x₂, and the depth folding function can be denoted as [symbol] (.,.) representing a sequence depth folding function for fusing an implicit output result of the previous layer (for instance, represented by a vector) and the additionally compressed input x_{j+i×s}. For instance, the [symbol] (.,.) function can easily implement a bitwise addition operation.

In this case, if the number where the j^{th} layer is located in the N network layers is less than the folding feature value s (for instance, (the depth-of-layer minus 1) is less than the folding feature value s), the input x′ of the i^{th} position of the j^{th} layer can be expressed as: xᵢ^{j}= [symbol] (hᵢ^{j-1}, x_{j+i×s}), j<s.

In this way, the solution provided in the present disclosure provides a specific solution for determining the input of the i^{th} position of the j^{th} layer. As such, the additionally introduced token of the second token sequence required for the input of the i^{th} position of the j^{th} layer can be quickly determined by using the solution, and further, no loss of the information of the compressed token can be effectively ensured. As such, the model training effect is ensured while the foundation for improving the model reasoning efficiency and reducing the cost required for training and deploying the model in the future is laid.

In a second manner: the input of the non-first layer (for instance, if j has a value of ranging from 1 to (N−1)) is determined. In a case where it is determined that the number where the j^{th} layer is located in the N network layers is greater than or equal to the folding feature value (for instance, in an example, if (the depth-of-layer minus 1) is greater than or equal to the folding feature value s), the input of the i^{th} position of the j^{th} layer is obtained based on an implicit output result of the (j−1)^{th} layer.

That is, in this example, if the number where the j^{th} (the value of j is an integer greater than 0 and less than N) layer is located in the N network layers is greater than or equal to the folding feature value (for instance, if (the depth-of-layer minus 1) is greater than or equal to the folding feature value s), the input of the i^{th} position of the j^{th} layer can be obtained directly based on the implicit output result of the (j−1)^{th} layer, without additionally introducing a token of the second token sequence. For instance, in an example, if the number where the j^{th} (the value of j is an integer greater than 0 and less than N) layer is located in the N network layers is greater than or equal to the folding feature value (for instance, if (the depth-of-layer minus 1) is greater than or equal to the folding feature value s), the implicit output result hᵢ^{j-1} of the i^{th} position of the (j−1)^{th} layer can be directly used as the input of the i^{th} position of the j^{th} layer.

For example, continuing with a preset model consisting of four network layers {L₀, L₁, L₂, L₃} and the initial token sequence {x₀, x₁, x₂, x₃} being folded twice to obtain the first token sequence {x₀, x₂} and the second token sequence {x₁, x₃} as examples, j has a value ranging from 0 to 3, and i has a value of 0 or 1. Further, as shown in FIG. 6(b), for the second layer L₂, j has a value of 2, and in this case, j≥s, an implicit output result h₀¹ of the 0th position of the first layer L₁ can be directly used as the input of the 0^{th} position of the second layer L₂, and an implicit output result h₁¹ of the first position of the first layer L₁ can be directly used as an input of a first position of the second layer L₂. Further, for the third layer L₃, j has a value of 3, and in this case, j≥s, an implicit output result h₀² of a 0^{th} position of the second layer L₂ can be directly used as an input of a 0^{th} position of the third layer L₃, and an implicit output result ha of a first position of the second layer L₂ can be directly used as an input of a first position of the third layer L₃.

For example, in an example, if the input of the i^{th} position of the j^{th} layer is denoted as x₂, and in this case, the number (for instance, a value of j) where the j^{th} (the non-first layer, for instance, a value of j is an integer greater than 0 and less than N) layer is located in the N network layers is greater than or equal to the folding feature value s, the input x′ of the i^{th} position of the j^{th} layer can be expressed as: xᵢ^{j}=hᵢ^{j-1}, j≥s.

That is, when the number where a layer is located is greater than or equal to the folding feature value (which can also be referred to be as a sequence depth folding multiple) s, the input of the i^{th} position of the j^{th} layer is the output of the previous layer, and no additionally folded and compressed tokens need to be fused.

It should be noted that according to the solution provided in the present disclosure, the length of the input required to be received by the model is linearly compressed. In order to ensure that information after the input is compressed is not lost, the compressed tokens are sequentially used as additional inputs of other layers except for the first layer in an original order of the inputs. Such a manner of the inputs fully utilizes the depth-of-layer dimension, effectively reduces the length of the input and avoids the loss of the information.

In this way, the solution provided in the present disclosure determines a specific solution for determining the input of the i^{th} position of the j^{th} layer. In the solution, the specific information of the inputs required by different network layers is determined by fully utilizing the depth-of-layer dimension of the network layer. As such, the loss of the information of the original input due to the compression is avoided while the input of the model is effectively compressed. Further, the model training speed is increased while the model training effect is ensured, and the foundation for improving the model reasoning ability and reducing the cost required for training and deploying the model in the future is laid.

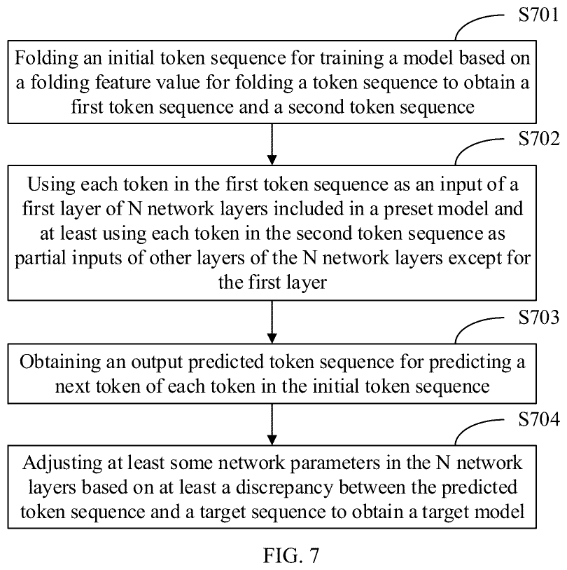

FIG. 7 is a third schematic flowchart of a model training method according to an embodiment of the present disclosure. The method is optionally applied to an electronic device, for instance, a personal computer, a server and a server cluster. It should be understood that relevant contents of methods shown in FIG. 1 to FIG. 6 above can be applied to this example, and will be omitted in this example.

Further, the method includes at least a portion of the following content. As shown in FIG. 7, the method includes the following steps.
Step S701: The initial token sequence for training a model is folded based on a folding feature value for folding a token sequence to obtain a first token sequence and a second token sequence.

Here, the initial token sequence represents a token sequence composed of T₁ tokens, and the first token sequence has a sequence length less than that of the initial token sequence.

Further, the first token sequence includes t₁₁ tokens displayed after being subjected to the folding, and the second token sequence includes t₁₂ tokens hidden by the tokens displayed after being subjected to the folding.

Here, relevant explanations on the initial token sequence, the first token sequence and the second token sequence can refer to the above examples, and will be omitted here.
Step S702: Each token in the first token sequence is used as an input of a first layer of N network layers included in a preset model and each token in the second token sequence is at least used as some inputs of other layers of the N network layers except for the first layer.

Here, relevant explanations on specific inputs of different network layers refer to the above examples, and will be omitted here.
Step S703: An output predicted token sequence for predicting the next token of each token in the initial token sequence is obtained.
Step S704: At least some network parameters in the N network layers are adjusted (for instance, fine-tuned) based on at least a discrepancy between the predicted token sequence and the target sequence (for instance, a pre-labeled theoretical token sequence) to obtain a target model.

In this way, the solution provided in the present disclosure provides a refined training solution for a preset model to obtain a trained model (i.e., the target model). As such, computational resources required for training the model are effectively reduced, and further the model training efficiency is improved. Moreover, the capability of the trained model to solve long-text tasks is improved, and the foundation for improving the model reasoning efficiency and reducing the cost required for training and deploying the model in the future is laid.

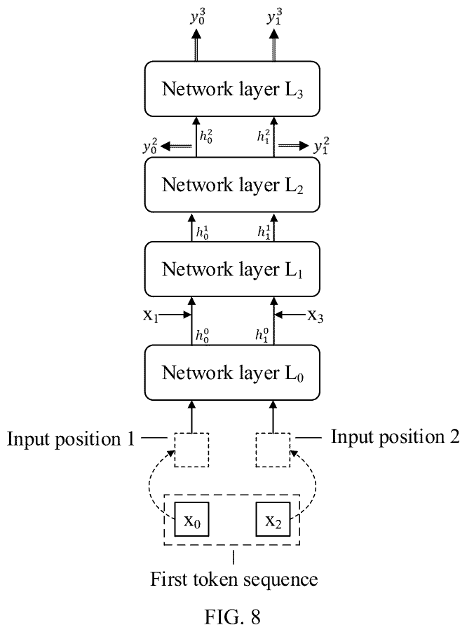

Further, in a specific example, the predicted token sequence includes a predicted token output by the last layer of the N network layers included in the preset model and predicted tokens output by other layers of the N network layers except for the last layer (for instance, the predicted tokens output by the last s (folding feature value) layers). For example, continuing with the preset model consisting of four network layers {L₀, L₁, L₂, L₃} and the initial token sequence {x₀, x₁, x₂, x₃} being folded twice to obtain the first token sequence {x₀, x₂} and the second token sequence {x₁, x₃} as examples, as shown in FIG. 8, the predicted token sequence includes predicted tokens y₀³ and y₁³ output by the network layer L₃ and predicted tokens y₀² and y₁² output by the network layer L₂. As such, single-step multi-token prediction is realized, and further the model reasoning and predicting speed is effectively improved.

Further, in an example, except for the last layer, the number where the network layer for the output predicted token is located is related to the folding feature value. For instance, the number (for instance, a value of j) where the network layer for the output predicted token is located is greater than the folding feature value. That is, it is necessary for not all network layers to output final prediction results and only some network layers (for instance, the last s layers) except for the last layer to output prediction results. As such, the foundation for improving the model reasoning efficiency and reducing the cost required for training and deploying the model is laid.

For instance, in an example, in a case where j is greater than or equal to a difference between the total number of the layers and the folding feature value s (for instance, for j having a value ranging from 0 to (N−1), in this case, particularly, j>N−1-s), the output of the i^{th} position of the j^{th} layer is used for predicting: x_{((s-1)-(N-1-j))+(i+1)×s}.

Here, i has a value depending a value of the T and the folding feature value.

Here, the relevant explanation of the value of i refers to the above example, and will be omitted here.

For example, continuing with FIG. 8 as an example, the total number of the network layers included in the preset model is 4, and the folding feature value is 2. In this case, i has a value of 0 or 1. Further, the output of the i^{th} position of the j^{th} layer is denoted as yᵢ^{j}. That is, in a case where j>N−1−s, the output yᵢ^{j} of the i^{th} position of the j^{th} layer for the predicted token has an expression: yᵢ^{j}˜x_{(s-1)-(N-1-j)+(i+1)×s}.

Or, in a case where j has a value ranging from 0 to 3, the output yᵢ^{j} of the i^{th} position of the j^{th} layer for the predicted token can particularly have an expression:

$${y}_{i}^{j} ∼ \{ \begin{matrix}{x}_{( ( s - 1 ) - ( N - 1 - j ) ) + ( i + 1 ) \times s} , & where j > N - 1 - s \\ ∅ , & where j \leq N - 1 - s\end{matrix} .$$

That is, in the last s layers (for instance, from the (N−1−s+1)^{th} layer to the (N−1)^{th} layer, a total of s layers) of the preset model, each layer needs to predict the next token of the input token. For instance, for the input of the i^{th} position, the token required for an (i+1)^{th} position is predicted.

It should be noted that yᵢ^{j} is used for the predicted token x_{((s-1)-(N-1-j))+(i+1)×s}, which can be particularly understood as: the token yᵢ^{j} is the next token of the predicted token x_{((s-1)-(N-1-j))+(i+1)×s-1}.

For example, continuing with FIG. 8 as an example, the predicted token sequence includes an output y₀² of the 0^{th} position of the second layer (for predicting x₂, which is the next token of the predicted token x₁), an output y₁² of the first position of the second layer (for predicting x₄, which is the next token of the predicted token x₃), an output y₀³ of the 0^{th} position of the third layer (for predicting x₃, which is the next token of the predicted token x₂), and an output y₁³ of the first position of the third layer (for predicting x₅, which is the next token of the predicted token x₄).

That is, in an output prediction phase of the solution of present disclosure, since one input position includes a plurality of compressed tokens (for instance, as shown in FIG. 8, an input position 1 includes two tokens, namely, a token x₀ and a token x₁), it is necessary to predict and output a plurality of tokens at the same input position in the output prediction phase. For example, in this phase, in comparison with a layer-wise sequential input manner, the plurality of tokens are predicted in sequence according to the original input order by using a depth-of-layer order during the outputting, such that the prediction reasoning is completed.

In this way, the solution provided in the present disclosure provides a specific solution for determining a predicted token required for an output position of an i^{th} position of a j^{th} layer. In this solution, the predicted tokens required for the output of different network layers is determined by fully utilizing the depth-of-layer dimension of the network layer. As such, prediction reasoning can be completed. As such, the model reasoning and predicting efficiency can be effectively improved, and further the foundation for improving the model reasoning ability and reducing the cost required for training and deploying the model in the future is laid.

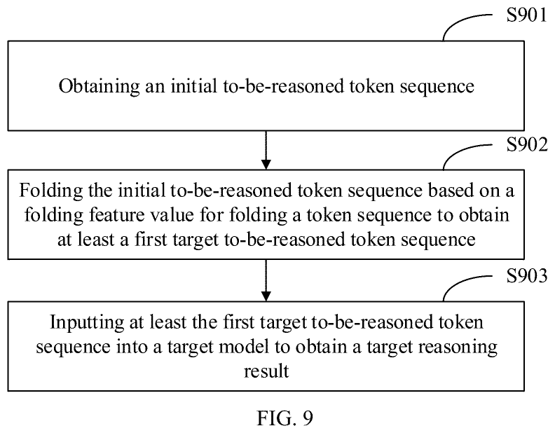

FIG. 9 is a first schematic flowchart of a model reasoning method according to an embodiment of the present disclosure. The method is optionally applied to an electronic device, for instance, a personal computer, a server and a server cluster.

Further, the method includes at least a portion of the following content. As shown in FIG. 9, the method includes the following steps.
Step S901: An initial to-be-reasoned token sequence is obtained.
Step S902: The initial to-be-reasoned token sequence is folded based on a folding feature value for folding a token sequence to obtain at least a first target to-be-reasoned token sequence.

Here, the initial to-be-reasoned token sequence represents a token sequence composed of T₂ tokens, and the first target to-be-reasoned token sequence obtained after the folding is performed includes some tokens of T₂ tokens. Further, the first target to-be-reasoned token sequence has a sequence length less than that of the initial to-be-reasoned token sequence.

Here, an example of folding the initial to-be-reasoned token sequence refers to an example corresponding to FIG. 2 above, and will be omitted here.
Step S903: At least the first target to-be-reasoned token sequence is input into a target model to obtain a target reasoning result.

Here, the target reasoning result is a next token sequence of the target to-be-reasoned token sequence obtained from prediction.

In this way, according to the solution provided in the present disclosure, the initial to-be-reasoned token sequence can be folded according to the folding feature value to obtain a token sequence subjected to the folding (i.e., the first target to-be-reasoned token sequence) having a length less than that of the initial to-be-reasoned token sequence. Further, the model can be reasoned by the target model according to the folded token sequence. As such, the model reasoning efficiency is improved and further the user experience is effectively enhanced by compressing the input of the model.

Further, in the solution provided in the present disclosure, since the length of the input of the model is compressed, the computational complexity and the video memory resource footprints can be effectively reduced, and further the cost required for reasoning the model is lowered. In addition, according to the solution provided in the present disclosure, the capability of the model to solve long-text tasks (for instance, long-text summarization and long-text questions and answers) is effectively improved.

In a specific example, the target model can be particularly a large model. Furthermore, the target model can be particularly a large language model. Alternatively, other models are also possible, and are not limited herein.

Further, the target model is trained by using any one of the model training methods.

Further, in a specific example, folding the initial target to-be-reasoned token sequence to obtain at least the first target to-be-reasoned token sequence (for instance, step S902) may particularly include: folding the initial to-be-reasoned token sequence to obtain the first target to-be-reasoned token sequence and a second target to-be-reasoned token sequence.

Correspondingly, inputting at least the first target to-be-reasoned token sequence into the target model to obtain a target reasoning result (for instance, step S903) particularly includes:
using each token in the first target to-be-reasoned token sequence as an input of a first layer of the N target network layers included in the preset model and at least using each token in the second target to-be-reasoned token sequence as some inputs of other layers of the N target network layers except for the first layer to obtain a target reasoning result.

For instance, in an example, each token in the first target to-be-reasoned token sequence can be input to a corresponding position of the first layer of the N target network layers included in the target model in an order of each token in the first target to-be-reasoned token sequence. Here, “position” can particularly refer to an input position of the token. Specific examples can refer to an example as shown in FIG. 5(a) above, and will be omitted here.

Further, the first target to-be-reasoned token sequence includes t₂₁ tokens displayed after being subjected to the folding, where the t₂₁ tokens are a part of the T₂ tokens. Further, the second target to-be-reasoned token sequence includes t₂₂ tokens hidden by the tokens displayed after being subjected to the folding, where the t₂₂ tokens are a part of the T₂ tokens. Here, t₂₁+t₂₂=T₁.

Here, relevant contents of the first target to-be-reasoned token sequence and the second target to-be-reasoned token sequence can refer to an example as shown in FIG. 4 above, and will be omitted here.

In this way, according to the solution provided in the present disclosure, each token in the first target to-be-reasoned token sequence subjected to the folding is used as the input of the first layer in the target model, and each token in the second target to-be-reasoned token sequence is used as inputs of other layers in the target model except for the first layer. As such, the integrity of the information of the input can be effectively ensured after the input of the model is compressed, and further the model reasoning effect is ensured while the model reasoning speed is increased.

Further, in a specific example, obtaining the target reasoning result particularly includes:
obtaining a target reasoning result output from the last position of the last n target network layers of the N target network layers.

Here, in an example, n has a value depending on the folding feature value s. Further, n=folding feature value. In this case, the target reasoning result output by the last position of the last s target network layers of the N target network layers can be obtained.

Further, the target reasoning result is at least the next token of the last token in the predicted initial to-be-reasoned token sequence. Further, the number of the tokens included in the target reasoning result is related to the folding feature value s. For instance, the number of the tokens included in the target reasoning result is equal to the folding feature value s.

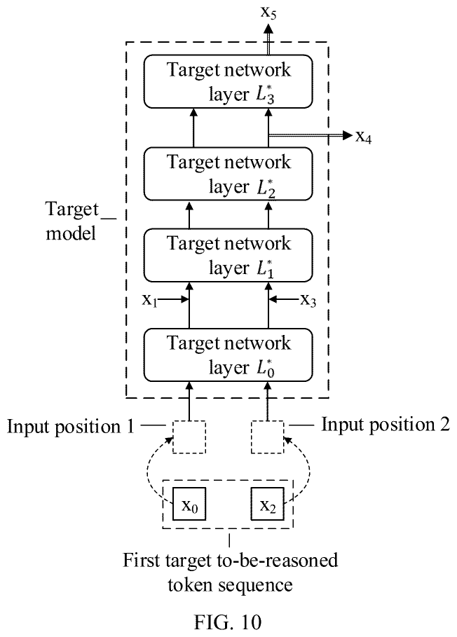

For example, with a target model consisting of four target network layers {L₀*, L₁*, L₂*, L₃*} and the initial to-be-reasoned token sequence {x₀, x₁, x₂, x₃} being folded twice to obtain a first target to-be-reasoned token sequence {x₀, x₂} and a second target to-be-reasoned token sequence {x₁, x₃} as examples, as shown in FIG. 10, an input of a last position of a target network layer L₀ included in the target model is x₂, and an input of a last position of a target network layer L₁* is x₃. In this case, the target model will predict a token y₁² and a token y₁³ according to the input x₂ of the last position of the target network layer L₀* and the input x₃ of the last position of the target network layer L₁*. Here, the token y₁² represents the next token of the predicted token x₃ (for instance, it can be a token x₄), and the token y₁³ represents the next token of the predicted token x₄ (for instance, it can be a token x₅).

In this way, the solution provided in the present disclosure can quickly obtain a target model reasoning result, effectively saving the computational resources required for reasoning the model. Moreover, a response can be provided to a user in real time and an accurate reasoning result is quickly provided, such that the user experience is improved.

Further, in an example, the N target network layers described above are connected in series. The output of the j^{th} layer of the N target network layers serves as the input of the (j+1)^{th} layer of the N target network layers. It should be noted that relevant contents of the example can refer to an example in FIG. 5(b) described above, and will be omitted here. As such, layer-wise feature extraction can be performed on the information of the input, and richer and deeper information is captured, which lays the foundation for improving the accuracy and the robustness of predicting the model.

In a specific example of the solution provided in the present disclosure, the input of each layer in the N target network layers can be obtained in the following way and particularly includes:
determining the input of the j^{th} layer of the N target network layers based on the folding feature value and the position where the j^{th} layer of the N target network layers is located in the N target network layers. Here, j has a value depending on the N. For instance, the value of j is a natural number greater than or equal to 0 and less than or equal to (N−1).

Further, in an example, determining the input of the j^{th} layer of the N target network layers based on the folding feature value and the position of the j^{th} layer of the N target network layers in the N target network layers may particularly include:
determining the input of the j^{th} layer of the N target network layers based on a numerical relationship between a number where the j^{th} layer of the N target network layers is located in the N target network layers and the folding feature value.

That is, in this example, the input of the first layer (for instance, when j has a value of 0) of the N target network layers included in the target model is the first target to-be-reasoned token sequence. Inputs of other layers of the N target network layers except for the first layer (i.e., when a value of j is an integer greater than 0 and less than N) need to be determined according to the numerical relationship between the number where the j^{th} layer of the N target network layers is located in the N target network layers and the folding feature value. As such, provided is a refined solution for determining that inputs of other token sequences in the initial to-be-reasoned token sequence except for the first target to-be-reasoned token sequence into the target model, which is simple and efficient.

In this way, the solution provided in the present disclosure provides a refined solution for determining how to input other token sequences (i.e., tokens covered by the folding) except for the first target to-be-reasoned token sequence into the target model according to a folding degree of the information of the input, which is simple and efficient. As such, the loss of the information due to the folding of the information of the input of the model is effectively avoided, the computational load of each target network layer is balanced, and the burden on the server when the information is processed by the model is reduced, which lays the foundation for increasing the model reasoning speed and reducing the cost required for reasoning the model.

Further, in a specific example, the input of the j^{th} layer of the N target network layers can be obtained particularly in the following way. Particularly, determining the input of the j^{th} layer of the N target network layers based on the numerical relationship between the number where the j^{th} layer of the N target network layers is located in the N target network layers and the folding feature value may particularly include at least one of the following two manners.

In a first manner: the input of the non-first layer (for example, when j has a value ranging from 1 to (N−1)) of the N target network layers is determined. Particularly, in a case where it is determined that the number (for instance, which can be understood as a value of j) where the j^{th} layer of the N target network layers is located in the N target network layers is less than the folding feature value (for instance, in an example, if (the depth-of-layer minus 1) is less than the folding feature value s), the input of the j^{th} layer of the N target network layers is obtained based on the implicit output result of the (j−1)^{th} layer of the N target network layers and at least one token in the second target to-be-reasoned token sequence.

Here, relevant contents on the number where the j^{th} layer of the N target network layers is located in the N target network layers, the depth-of-layer and the implicit output result refer to the above example, and will be omitted here.

It should be noted that in an example, j has a value ranging from 0 to (N−1). Further, the solution provided in the present disclosure is exemplarily explained by using j having a value ranging from 0 to (N−1) as an example. It can be understood that j can have a value ranging from 1 to N. In this case, corner markers can be adjusted accordingly based on an actual value, and are not limited herein.

It can be understood that the input of the first layer (for instance, j has a value of 0) of the N target network layers is each token in the first target to-be-reasoned token sequence. The input of the non-first layer of the N target network layers can be obtained based on the first manner. For instance, with j having a value of 1 and the folding feature value being 2 as examples, j is less than s or (the depth-of-layer minus 1) (for instance, 2 minus 1) is less than 2, the input of the first layer of the N target network layers can be particularly the implicit output result of the 0^{th} layer of the N target network layers and at least one token in the second target to-be-reasoned token sequence (i.e., one token covered by the folding). In other words, in a scenario, for some layers meeting conditions, in addition to using the implicit output result of the previous layer (for instance, the (j−1)^{th} layer of the N target network layers) as the input of the next layer (for instance, the j^{th} layer of the N target network layers), it is necessary to additionally introduce the token hidden by the token displayed after being subjected to the folding as another input of the next layer (for instance, the j^{th} layer of the N target network layers). As such, the foundation for effectively avoiding the loss of information of the original input is laid.

Further, in an example, obtaining the input of the j^{th} layer of the N target network layers based on the implicit output result of the (j−1)^{th} layer of the N target network layers and at least one token in the second target to-be-reasoned token sequence as described in the first manner can particularly include:
obtaining an input of an i^{th} position of the j^{th} layer of the N target network layers based on an implicit output result hᵢ^{j-1} of an i^{th} position of a (j−1)^{th} layer of the N target network layers and a token x_{j+i×s}.

Here, j represents the number of a layer; and i represents the input position of the token, and has a value depending on the value of the T₂ and the folding feature value. For instance, in an example, i has a value ranging from 0 to [(T₂/s)−1]. s represents the folding feature value.

Here, relevant contents on this section refer to the example shown in FIG. 6(a) above, and will be omitted here.

In this way, according to the solution provided in the present disclosure, at least one token of the second target to-be-reasoned token sequence is additionally introduced into the input of the target network layer meeting a depth-of-layer requirement. As such, the loss of information of the original input is effectively avoided. In other words, according to the solution provided in the present disclosure, a specific position required to be input by the compressed token is obtained by utilizing the depth dimension of the target network layer while the input of the preset model is compressed, such that the loss of the information of the original input is effectively avoided, and further the model reasoning speed is increased while the model training effect is ensured.

Further, in a specific example, obtaining the input of the i^{th} position of the j^{th} layer of the N target network layers based on the implicit output result hᵢ^{j-1} of the i^{th} position of the (j−1)^{th} layer of the N target network layers and the token x_{j+i×s} may particularly include:
fusing the implicit output result hᵢ^{j-1} of the i^{th} position of the (j−1)^{th} layer of the N target network layers and the token x_{j+i×s} by using a deep folding function so as to use a fused result as the input of the i^{th} position of the j^{th} layer of the N target network layers.

For example, in an example, the input of the i^{th} position of the j^{th} layer of the N target network layers can be denoted as x′, and the depth folding function can be denoted as [symbol] (.,.), representing a sequence depth folding function for fusing an implicit output result of the previous layer (for instance, represented by a vector) with the additionally compressed input x_{j+i×s}. For instance, the [symbol] (.,.) function can easily implement a bitwise addition operation.

In this case, in a case where the number where the j^{th} layer of the N target network layers is located in the target N network layers is less than the folding feature value s (for instance, in a case where (the depth-of-layer minus 1) is less than the folding feature value s), the input xᵢ^{j} of the i^{th} position of the j^{th} layer of the N target network layers can be expressed as: xᵢ^{j}= [symbol] (hᵢ^{j-1}, x_{j+i×s}), j<s.

In this way, the solution provided in the present disclosure provides a specific solution for determining the input of the i^{th} position of the j^{th} layer of the N target network layers. As such, the additionally introduced token of the second target to-be-reasoned token sequence required for the input of the i^{th} position of the j^{th} layer of the N target network layers can be quickly determined by using the solution, and further no loss of the compressed information of the token is ensured. As such, the model reasoning efficiency is improved while the model training effect is ensured.

In a second manner 2: the input of the non-first layer (for instance, when j has a value ranging from 1 to (N−1)) of the N target network layers is determined. Particularly, in a case where it is determined that the number where the j^{th} layer of the N target network layers is located in the N target network layers is greater than or equal to the folding feature value (for instance, in an example, if (the depth-of-layer minus 1) is greater than or equal to the folding feature value s), the input of the i^{th} position of the j^{th} layer of the N target network layers is obtained based on an implicit output result of the (j−1)^{th} layer of the N target network layers.

That is, in this example, in a case where the number where the j^{th} layer of the N target network layers is located in the N target network layers (a value of j is an integer greater than 0 and less than N) is greater than or equal to the folding feature value (for instance, if (the depth-of-layer minus 1) is greater than or equal to the folding feature value s), the input of the i^{th} position of the j^{th} layer of the N target network layers can be obtained directly based on the implicit output result of the (j−1)^{th} layer of the N target network layers, without additionally introducing a token of the second target to-be-reasoned token sequence. For instance, in an example, in a case where the number where the j^{th} layer of the N target network layers is located in the N target network layers (a value of j is an integer greater than 0 and less than N) is greater than or equal to the folding feature value (for instance, if (the depth-of-layer minus 1) is greater than or equal to the folding feature value s), the implicit output result hᵢ^{j-1} of the i^{th} position of the (j−1)^{th} layer of the N target network layers can be directly used as the input of the i^{th} position of the j^{th} layer of the N target network layers. That is, when the number where a layer is located is greater than or equal to the folding feature value (which can also be referred to be as the sequence depth folding multiple) s, the input of the i^{th} position of the j^{th} layer is the output of the previous layer, and no additionally folded and compressed tokens need to be fused.

Here, relevant contents on this example can refer to the example shown in FIG. 6(b), and will be omitted here.

It should be noted that according to the solution provided in the present disclosure, the length of the input required to be received by the model is linearly compressed. In order to ensure that the information after the input is compressed is not lost, the compressed tokens are sequentially used as additional inputs of other layers except for the first layer in an order of original inputs. Such a manner of the inputs fully utilizes the depth-of-layer dimension, effectively reduces the length of the input and avoids the loss of the information.

In this way, the solution provided in the present disclosure determines a specific solution for determining the input of the i^{th} position of the j^{th} layer of the N target network layers. In the solution, specific information of the inputs required by different network layers is determined by fully utilizing the depth-of-layer dimension of the target network layer. As such, the loss of the information of the original input due to the compression is avoided while the input of the model is effectively compressed. Further, the model reasoning speed is increased while the model training effect is ensured.

In summary, the solution provided in the present disclosure has the following advantages.

Firstly, the efficiency is relatively high. Compared with an improved solution of an efficient Transformer structure, the solution provided in the present disclosure is simple to implement and can improve the model training and reasoning efficiency in practical application scenarios. Moreover, the solution provided in the present disclosure will not be affected by the compression of the information of the input, thereby supporting the infinite long-text input.

Secondly, the training efficiency and the reasoning efficiency are realized. Compared with the efficient reasoning solution in low-resource scenarios, the solution provided in the present disclosure not only plays an acceleration role in a training phase, but also improves the efficiency in a reasoning phase, and achieves the integration of training and reasoning, thereby ensuring better results.

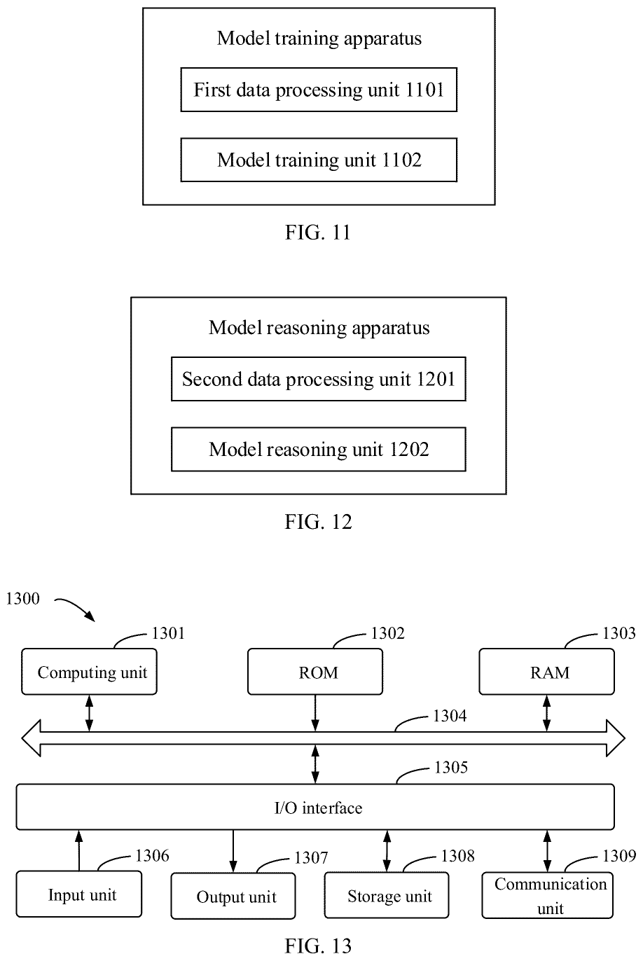

The solution provided in the present disclosure provides a model training apparatus, as shown in FIG. 11, including:
a first data processing unit 1101, configured to fold an initial token sequence for training a model based on a folding feature value for folding a token sequence to obtain at least a first token sequence subjected to the folding, where the initial token sequence represents a token sequence composed of T₁ tokens, and the first token sequence has a sequence length less than that of the initial token sequence; and
a model training unit 1102, configured to input at least the first token sequence into a preset model to train the preset model so as to obtain a target model.

In a specific example of the solution provided in the present disclosure, the first data processing unit is particularly configured to fold the initial token sequence to obtain the first token sequence and a second token sequence, where the first token sequence includes t₁₁ tokens displayed after being subjected to the folding, and the second token sequence includes t₁₂ tokens hidden by the tokens displayed after being subjected to the folding; and

the model training unit is particularly configured to adjust at least some network parameters in the N network layers by using each token in the first token sequence as an input of a first layer of N network layers included in the preset model and at least using each token in the second token sequence as partial inputs of other layers of the N network layers except for the first layer, to obtain the target model.

In a specific example of the solution provided in the present disclosure, the N network layers are connected in series, and an output of a j^{th} layer of the N network layers serves as an input of a (j+1)^{th} layer of the N network layers.

In a specific example of the solution provided in the present disclosure, the first data processing unit is further configured to determine an input of the j^{th} layer based on the folding feature value and a position where the j^{th} layer of the N network layers is located in the N network layers, where j has a value depending on the N.

In a specific example of the solution provided in the present disclosure, the first data processing unit is particularly configured to:
determine an input of the j^{th} layer based on a numerical relationship between a number where the j^{th} layer is located in the N network layers and the folding feature value.

In a specific example of the solution provided in the present disclosure, the first data processing unit is particularly configured to:
in a case of determining that the number where the j^{th} layer is located in the N network layers is less than the folding feature value, obtain an input of the j^{th} layer based on an implicit output result of a (j−1)^{th} layer and at least one token in the second token sequence; or,
in a case of determining that the number where the j^{th} layer is located in the N network layers is greater than or equal to the folding feature value, obtain an input of an i^{th} position of the j^{th} layer based on an implicit output result of a (j−1)^{th} layer.

In a specific example of the solution provided in the present disclosure, where the first data processing unit is particularly configured to:
obtain an input of an i^{th} position of the j^{th} layer based on an implicit output result hᵢ^{j-1} of an i^{th} position of the (j−1)^{th} layer and a token x_{j+i×s}, where i has a value depending on a value of the T₁ and the folding feature value, and s represents the folding feature value.

In a specific example of the solution provided in the present disclosure, the first data processing unit is particularly configured to:
fuse the implicit output result hᵢ^{j-1} of the i^{th} position of the (j−1)^{th} layer and the token x_{j+i×s} by using a deep folding function so as to use a fused result as the input of the i^{th} position of the j^{th} layer.

In a specific example of the solution provided in the present disclosure, the first data processing unit is particularly configured to:
use an implicit output result hᵢ^{j-1} of an i^{th} position of a (j−1)^{th} layer as the input of the i^{th} position of the j^{th} layer.

In a specific example of the solution provided in the present disclosure, the model training unit is particularly configured to:
use each token in the first token sequence as the input of the first layer of the N network layers included in the preset model and at least use each token in the second token sequence as partial inputs of other layers of the N network layers except for the first layer;
obtain an output predicted token sequence for predicting a next token of each token in the initial token sequence; and
adjust the at least some network parameters in the N network layers based on at least a discrepancy between the predicted token sequence and a target sequence to obtain the target model.

In a specific example of the solution provided in the present disclosure, the predicted token sequence includes a predicted token output by the last layer of the N network layers included in the preset model and predicted tokens output by other partial layers of the N network layers except for the last layer.

In a specific example of the solution provided in the present disclosure, except for the last layer, the number of the network layers for the output predicted tokens is related to the folding feature value.

In a specific example of the solution provided in the present disclosure, the number of the network layers for the output predicted tokens is greater than the folding feature value.

In a specific example of the solution provided in the present disclosure, in a case where j is greater than or equal to a difference between the total number of the layers and the folding feature value s, the predicted token output from the i^{th} position of the j^{th} layer is used for predicting:

$${x}_{( ( s - 1 ) - ( N - 1 - j ) ) + ( i + 1 ) \times s} ;$$

where i has a value depending on a value of the T and the folding feature value.

The solution provided in the present disclosure further provides a model reasoning apparatus, as shown in FIG. 12, including:
a second data processing unit 1201, configured to obtain an initial to-be-reasoned token sequence, and fold the initial to-be-reasoned token sequence based on a folding feature value for folding a token sequence to obtain at least a first target to-be-reasoned token sequence, where the initial to-be-reasoned token sequence represents a token sequence composed of T₂ tokens, and the first target to-be-reasoned token sequence has a sequence length less than that of the initial to-be-reasoned token sequence; and
a model reasoning unit 1202, configured to input at least the first target to-be-reasoned token sequence into a target model to obtain a target reasoning result, where the target reasoning result is a next token sequence of the target to-be-reasoned token sequence obtained from the prediction.

In a specific example of the solution provided in the present disclosure, the second data processing unit is particularly configured to: fold the initial to-be-reasoned token sequence to obtain the first target to-be-reasoned token sequence and a second target to-be-reasoned token sequence, where the first target to-be-reasoned token sequence includes t₂₁ tokens displayed after being subjected to the folding, and the second target to-be-reasoned token sequence includes t₂₂ tokens hidden by the tokens displayed after being subjected to the folding; and
the model reasoning unit is particularly configured to: use each token in the first target to-be-reasoned token sequence as an input of a first layer of N target network layers included in the preset model and at least use each token in the second target to-be-reasoned token sequence as partial inputs of other layers in the N target network layers except for the first layer to obtain a target reasoning result.

In a specific example of the solution provided in the present disclosure, the N target network layers are connected in series, and an output of a j^{th} layer of the N target network layers serves as an input of a (j+1)^{th} layer of the N target network layers.

In a specific example of the solution provided in the present disclosure, the second data processing unit is further configured to determine an input of the j^{th} layer of the N target network layers based on the folding feature value and a position where the j^{th} layer of the N target network layers is located in the N target network layers, where j has a value depending on the N.

In a specific example of the solution provided in the present disclosure, the second data processing unit is particularly configured to:
determine the input of the j^{th} layer of the N target network layers based on a numerical relationship between a number where the j^{th} layer of the N target network layers is located in the N target network layers and the folding feature value.

In a specific example of the solution provided in the present disclosure, the second data processing unit is particularly configured to:
in a case of determining that the number where the j^{th} layer of the N target network layers is located in the N target network layers is less than the folding feature value, obtain the input of the j^{th} layer of the N target network layers based on an implicit output result of a (j−1)^{th} layer of the N target network layers and at least one token in the second target to-be-reasoned token sequence; or,
in a case of determining that the number where the j^{th} layer of the N target network layers is located in the N target network layers is greater than or equal to the folding feature value, obtain an input of an i^{th} position of the j^{th} layer of the N target network layers based on an implicit output result of a (j−1)^{th} layer of the N target network layers.

In a specific example of the solution provided in the present disclosure, the second data processing unit is particularly configured to:
obtain an input of an i^{th} position of the j^{th} layer of the N target network layers based on an implicit output result hᵢ^{j-1} of an i^{th} position of a (j−1)^{th} layer of the N target network layers and a token x_{j+i×s}, where i has a value depending on a value of the T₂ and the folding feature value, and s represents the folding feature value.

In a specific example of the solution provided in the present disclosure, the second data processing unit is particularly configured to:
fuse the implicit output result hᵢ^{j-1} of the i^{th} position of the (j−1)^{th} layer of the N target network layers and the token x_{j+i×s} by using a deep folding function so as to use a fused result as the input of the i^{th} position of the j^{th} layer of the N target network layers.

In a specific example of the solution provided in the present disclosure, the second data processing unit is particularly configured to:
use the implicit output result hᵢ^{j-1} of the i^{th} position of the (j−1)^{th} layer of the N target network layers as the input of the i^{th} position of the j^{th} layer of the N target network layers.

In a specific example of the solution provided in the present disclosure, the model reasoning unit is particularly configured to:
obtain a target reasoning result output from the last position of the last n target network layers of the N target network layers, where the target reasoning result is at least a next token of the last token in the initial to-be-reasoned token sequence obtained from the prediction.

The description of specific functions and examples of the units of the apparatus of the embodiments of the present disclosure can be found in the relevant descriptions of the corresponding steps in the method of the embodiments, and will be omitted here.

In the technical solution provided in the present disclosure, the acquisition, storage and application of personal information of users involved are in accordance with relevant laws and regulations and do not violate public order and morals.

According to an embodiment of the present disclosure, the present disclosure further provides an electronic device, a readable storage medium and a computer program product.

FIG. 13 shows a schematic block diagram of an example electronic device 1300 which can be used to implement an embodiment of the present disclosure. The electronic device is designed to represent various forms of digital computers, such as laptop computers, desktop computers, workbenches, personal digital assistants, servers, blade servers, mainframe computers and other suitable computers. The electronic device can further represent various forms of mobile devices, such as personal digital assistants, cellular phones, smartphones, wearable devices and other similar computing apparatuses. Components, their connections and relationships, and their functions shown herein are only examples and are not intended to limit an implementation of the present disclosure described and/or required herein.

As shown in FIG. 13, the device 1300 includes a computing unit 1301 which can perform various appropriate actions and processes according to computer programs stored in a read-only memory (ROM) 1302 or loaded from a storage unit 1308 into a random access memory (RAM) 1303. Various programs and data required for the operation of the device 1300 can be stored in the RAM 1303. The computing unit 1301, the ROM 1302 and the RAM 1303 are connected to each other via a bus 1304. An input/output (I/O) interface 1305 is also connected to the bus 1304.

A plurality of components in the device 1300 are connected to the I/O interface 1305, including an input unit 1306 such as a keyboard and a mouse, an output unit 1307 such as various types of displays and speakers, the storage unit 1308 such as a disk and a CD, and a communication unit 1309 such as a network card, a modem and a wireless communication transceiver. The communication unit 1309 allows the device 1300 to exchange information/data with other devices through computer networks such as the Internet and/or various telecommunications networks.

The computing unit 1301 can be various general-purpose and/or special-purpose processing components with processing and computing capabilities. Some examples of the computing unit 1301 include but are not limited to central processing units (CPUs), graphics processing units (GPUs), various special-purpose artificial intelligence (AI) computing chips, various computing units running machine learning model algorithms, digital signal processors (DSPs), and any suitable processors, controllers, microcontrollers, and the like. The computing unit 1301 executes various methods and processes described above, such as a model training method or a model reasoning method. For example, in some embodiments, the model training method or the model reasoning method may be implemented as a computer software program tangibly contained in a machine-readable medium, such as the storage unit 1308. In some embodiments, some or all of the computer programs may be loaded and/or installed onto the device 1300 via the ROM 1302 and/or the communication unit 1309. When the computer programs are loaded into the RAM 1303 and executed by the computing unit 1301, one or more steps of the model training method or the model reasoning method described above can be performed. Alternatively, in other embodiments, the computing unit 1301 may be configured to perform the model training method or the model reasoning method through any other suitable means (e.g., by means of firmware).

Various implementations of systems and technologies described above in the present disclosure can be implemented in a digital electronic circuit system, an integrated circuit system, a field programmable gate array (FPGA), an application specific integrated circuit (ASIC), an application specific standard product (ASSP), a system on chip (SOC) system, a complex programmable logic device (CPLD), computer hardware, firmware, software, and/or a combination thereof. These various implementations may include: implementation in one or more computer programs, the one or more computer programs are executable and/or interpretable on a programmable system including at least one programmable processor which may be a special-purpose or general-purpose programmable processor and can receive data and instructions from a storage system, at least one input apparatus and at least one output apparatus and transmit the data and the instructions to the storage system, the at least one input apparatus and the at least one output apparatus.

A program code for implementing the method of the present disclosure can be written in any combination of one or more programming languages. These program codes can be provided to a processor or a controller of a general-purpose computer, a special-purpose computer, or other programmable data processing apparatuses, such that the program code, when executed by the processor or the controller, implements functions/operations specified in the flowchart and/or the block diagram. The program code can be executed entirely on a machine, partially on a machine, partially on a machine as a standalone software package and partially on a remote machine, or entirely on a remote machine or a server.

In the context of the present disclosure, a machine-readable medium may be a tangible medium containing or storing a program for use by or in combination with an instruction execution system, apparatus or device. The machine-readable medium can be a machine-readable signal medium or machine-readable storage medium. The machine-readable medium may include, but is not limited to, an electronic, magnetic, optical, electromagnetic, infrared, or semiconductor system, apparatus and device, or any suitable combination of the above. More specific examples of the machine-readable storage medium include an electrical connection based on one or more wires, a portable computer disk, a hard drive, a random access memory (RAM), a read-only memory (ROM), an erasable programmable read-only memory (EPROM or flash memory), an optical fiber, a compact disc read-only memory (CD-ROM), an optical storage device, a magnetic storage device, or any suitable combination of the above.

In order to provide the interaction with the user, a system and a technology described herein can be implemented on a computer equipped with a display apparatus (for example, a CRT (cathode ray tube) or LCD (liquid crystal display) monitor) for displaying information to a user; and a keyboard and a pointing apparatus (for example, a mouse or a trackball), through which the user can provide an input to the computer. Other types of apparatuses can be used to provide the interaction with the user. For example, feedback provided to the user can be any form of sensory feedback (for example, visual feedback, auditory feedback or tactile feedback), and can receive the input from the user in any form (including sound input, speech input or tactile input).

A system and a technology described herein can be implemented in a computing system including a backend component (for example, as a data server), or a computing system including a middleware component (for example, an application server), or a computing system including a frontend component (for example, a user computer with a graphical user interface or a web browser, through which the user can interact with the implementation of the system and the technology described herein), or a computing system including any combination of the backend component, the middleware component or the frontend component. The components of the system can be interconnected through any form or medium of digital data communication (for example, a communication network). Examples of the communication network include a local area network (LAN), a wide area network (WAN) and the Internet.

The computer system can include a client and a server. The client and the server are generally far apart from each other and typically interact through the communication network. A client-server relationship is generated by computer programs running on corresponding computers and having the client-server relationship with each other. The server can be a cloud server, or a server of a distributed system, or a server combining a blockchain.

It should be understood that steps can be reordered, added or deleted by using various forms of processes shown above. For example, the steps described in the present disclosure can be performed in parallel, or sequentially or in different orders provided that the desired results of the technical solution disclosed in the present disclosure can be achieved, and are not limited herein.

The detailed description does not constitute a limitation on the scope of protection of the present disclosure. It should be understood by those skilled in the art that various modifications, combinations, sub-combinations and substitutions can be made based on design requirements and other factors. Any modifications, equivalent substitutions and improvements made within the principles of the present disclosure shall be included within the scope of protection of the present disclosure.

What is claimed is:

1. A model training method, comprising:
folding an initial token sequence for training the model based on a folding feature value for folding a token sequence to obtain at least a first token sequence subjected to the folding, wherein the initial token sequence represents a token sequence composed of T₁ tokens, and the first token sequence has a sequence length less than that of the initial token sequence; and
inputting at least the first token sequence into a preset model to train the preset model so as to obtain a target model.

2. The method of claim 1, wherein folding the initial token sequence for training the model to obtain at least the first token sequence subjected to the folding comprises:
folding the initial token sequence to obtain the first token sequence and a second token sequence, wherein the first token sequence comprises t₁₁ tokens displayed after being subjected to the folding, and the second token sequence comprises t₁₂ tokens hidden by the tokens displayed after being subjected to the folding;
wherein inputting at least the first token sequence into the preset model to train the preset model so as to obtain the target model comprises:
adjusting at least some network parameters in the N network layers by using each token in the first token sequence as an input of a first layer of the N network layers comprised in the preset model and at least using each token in the second token sequence as partial inputs of other layers of the N network layers except for the first layer, to obtain the target model;
wherein the N network layers are connected in series, and an output of a j^{th} layer of the N network layers serves as an input of a (j+1)^{th} layer of the N network layers.

3. The method of claim 2, further comprising:
determining an input of the j^{th} layer based on the folding feature value and a position where the j^{th} layer of the N network layers is located in the N network layers, wherein j has a value depending on the N.

4. The method of claim 3, wherein determining the input of the j^{th} layer based on the folding feature value and the position where the j^{th} layer of the N network layers is located in the N network layers comprises:
determining the input of the j^{th} layer based on a numerical relationship between a number where the j^{th} layer is located in the N network layers and the folding feature value.

5. The method of claim 4, wherein determining the input of the j^{th} layer based on the numerical relationship between the number where the j^{th} layer is located in the N network layers and the folding feature value comprises:
in a case of determining that the number where the j^{th} layer is located in the N network layers is less than the folding feature value, obtaining an input of the j^{th} layer based on an implicit output result of a (j−1)^{th} layer and at least one token in the second token sequence;
or,
in a case of determining that the number where the j^{th} layer is located in the N network layers is greater than or equal to the folding feature value, obtaining an input of an i^{th} position of the j^{th} layer based on an implicit output result of a (j−1)^{th} layer.

6. The method of claim 5, wherein obtaining the input of the j^{th} layer based on the implicit output result of the (j−1)^{th} layer and the at least one token in the second token sequence comprises:
obtaining an input of an i^{th} position of the j^{th} layer based on an implicit output result hᵢ^{j-1} of an i^{th} position of the (j−1)^{th} layer and a token x_{j+i×s}, wherein i has a value depending on a value of the T₁ and the folding feature value, and s represents the folding feature value;
wherein obtaining the input of the i^{th} position of the j^{th} layer based on the implicit output result hᵢ^{j-1} of the i^{th} position of the (j−1)^{th} layer and the token x_{j+i×s} comprises:
fusing the implicit output result hᵢ^{j-1} of the i^{th} position of the (j−1)^{th} layer and the token x_{j+i×s} by using a deep folding function so as to use a fused result as the input of the i^{th} position of the j^{th} layer.

7. The method of claim 5, wherein obtaining the input of the i^{th} position of the j^{th} layer based on the implicit output result of the (j−1)^{th} layer comprises:
using an implicit output result hᵢ^{j-1} of an i^{th} position of a (j−1)^{th} layer as the input of the i^{th} position of the j^{th} layer.

8. The method of claim 2, wherein adjusting the at least some network parameters in the N network layers by using each token in the first token sequence as the input of the first layer of the N network layers comprised in the preset model and at least using each token in the second token sequence as partial inputs of other layers of the N network layers except for the first layer to obtain the target model comprises:
using each token in the first token sequence as the input of the first layer of the N network layers comprised in the preset model and at least using each token in the second token sequence as partial inputs of other layers of the N network layers except for the first layer;
obtaining an output predicted token sequence for predicting a next token of each token in the initial token sequence; and
adjusting the at least some network parameters in the N network layers based on a discrepancy between the predicted token sequence and a target sequence to obtain the target model;
wherein the predicted token sequence comprises a predicted token output by the last layer of the N network layers comprised in the preset model and predicted tokens output by other partial layers of the N network layers except for the last layer;
wherein the number of the network layers for the output predicted tokens except for the last layer is related to the folding feature value;
wherein the number of the network layers for the output predicted tokens is greater than the folding feature value;
wherein in a case where j is greater than or equal to a difference between the total number of the layers and the folding feature value s, the predicted token output from the i^{th} position of the j^{th} layer is used for predicting:
$${x}_{( ( s - 1 ) - ( N - 1 - j ) ) + ( i + 1 ) \times s} ;$$
wherein i has a value depending on a value of the T₁ and the folding feature value.

9. A model reasoning method, comprising:
obtaining an initial to-be-reasoned token sequence;
folding the initial to-be-reasoned token sequence based on a folding feature value for folding a token sequence to obtain at least a first target to-be-reasoned token sequence, wherein the initial to-be-reasoned token sequence represents a token sequence composed of T₂ tokens, and the first target to-be-reasoned token sequence has a sequence length less than that of the initial to-be-reasoned token sequence; and
inputting at least the first target to-be-reasoned token sequence into a target model to obtain a target reasoning result, wherein the target reasoning result is a next token sequence of the target to-be-reasoned token sequence obtained from prediction.

10. The method of claim 9, wherein folding the initial to-be-reasoned token sequence to obtain at least the first target to-be-reasoned token sequence comprises:
folding the initial to-be-reasoned token sequence to obtain the first target to-be-reasoned token sequence and a second target to-be-reasoned token sequence, wherein the first target to-be-reasoned token sequence comprises t₂₁ tokens displayed after being subjected to the folding, and the second target to-be-reasoned token sequence comprises t₂₂ tokens hidden by the tokens displayed after being subjected to the folding;
wherein inputting at least the first target to-be-reasoned token sequence into the target model to obtain the target reasoning result comprises:
using each token in the first target to-be-reasoned token sequence as an input of a first layer of N target network layers comprised in the target model and at least using each token in the second target to-be-reasoned token sequence as partial inputs of other layers of the N target network layers except for the first layer to obtain a target reasoning result;
wherein the N target network layers are connected in series, and an output of a j^{th} layer of the N target network layers serves as an input of a (j+1)^{th} layer of the N target network layers.

11. The method of claim 10, further comprising:
determining an input of the j^{th} layer of the N target network layers based on the folding feature value and a position where the j^{th} layer of the N target network layers is located in the N target network layers, wherein j has a value depending on the N.

12. The method of claim 11, wherein determining the input of the j^{th} layer of the N target network layers based on the folding feature value and the position where the j^{th} layer of the N target network layers is located in the N target network layers comprises:
determining the input of the j^{th} layer of the N target network layers based on a numerical relationship between a number where the j^{th} layer of the N target network layers is located in the N target network layers and the folding feature value.

13. The method of claim 12, wherein determining the input of the j^{th} layer of the N target network layers based on the numerical relationship between the number where the j^{th} layer of the N target network layers is located in the N target network layers and the folding feature value comprises:
in a case of determining that the number where the j^{th} layer of the N target network layers is located in the N target network layers is less than the folding feature value, obtaining the input of the j^{th} layer of the N target network layers based on an implicit output result of a (j−1)^{th} layer of the N target network layers and at least one token in the second target to-be-reasoned token sequence;
or,
in a case of determining that the number where the j^{th} layer of the N target network layers is located in the N target network layers is greater than or equal to the folding feature value, obtaining an input of an i^{th} position of the j^{th} layer of the N target network layers based on an implicit output result of a (j−1)^{th} layer of the N target network layers.

14. The method of claim 13, wherein obtaining the input of the j^{th} layer of the N target network layers based on an implicit output result of the (j−1)^{th} layer of the N target network layers and the at least one token in the second target to-be-reasoned token sequence comprises:
obtaining an input of an i^{th} position of the j^{th} layer of the N target network layers based on an implicit output result hᵢ^{j-1} of an i^{th} position of a (j−1)^{th} layer of the N target network layers and a token x_{j+i×s}, wherein i has a value depending on a value of the T₂ and the folding feature value, and s represents the folding feature value;
wherein obtaining the input of the i^{th} position of the j^{th} layer of the N target network layers based on the implicit output result hᵢ^{j-1} of the i^{th} position of the (j−1)^{th} layer of the N target network layers and the token x_{j+i×s} comprises:
fusing the implicit output result hᵢ^{j-1} of the i^{th} position of the (j−1)^{th} layer of the N target network layers and the token x_{j+i×s} by using a deep folding function so as to use a fused result as the input of the i^{th} position of the j^{th} layer of the N target network layers.

15. The method of claim 13, wherein obtaining the input of the i^{th} position of the j^{th} layer of the N target network layers based on the implicit output result of the (j−1)^{th} layer of the N target network layers comprises:
using an implicit output result hᵢ^{j-1} of an i^{th} position of the (j−1)^{th} layer of the N target network layers as the input of the i^{th} position of the j^{th} layer of the N target network layers.

16. The method of claim 10, wherein obtaining the target reasoning result comprises:
obtaining a target reasoning result output from the last position of last n target network layers of the N target network layers, wherein the target reasoning result is at least a next token of the last token in the initial to-be-reasoned token sequence obtained from prediction.

17. An electronic device, comprising:
at least one processor; and
a memory, connected in communication with at least one processor,
wherein the memory stores an instruction executable by the at least one processor, and the instruction, when executed by the at least one processor, enables the at least one processor to perform the method of claim 1.

18. An electronic device, comprising:
at least one processor; and
a memory, connected in communication with at least one processor,
wherein the memory stores an instruction executable by the at least one processor, and the instruction, when executed by the at least one processor, enables the at least one processor to perform the method of claim 9.

19. A non-transitory computer-readable storage medium storing a computer instruction thereon, wherein the computer instruction is used to cause a computer to perform the method of claim 1.

20. A non-transitory computer-readable storage medium storing a computer instruction thereon, wherein the computer instruction is used to cause a computer to perform the method of claim 9.
